(19) United States
(12) Patent Application Publication
(10) Pub. No.: US 2002/0055949 A1
(43) Pub. Date: May 9, 2002

(54) Information processing apparatus, communication apparatus, information processing terminal, information supplying apparatus, information supplying method, information supplying system and computer readable recording medium, providing desired information together with related advertisement information

(76) Inventors: Masashi Shiomi, Soraku-gun (JP); Shuichi Yoshikawa, Nara-shi (JP); Teruaki Morita, Kitakatsuragi-gun (JP); Masayuki Ehiro, Izumi-shi (JP)

Correspondence Address: BIRCH STEWART KOLASCH & BIRCH, PO BOX 747, FALLS CHURCH, VA, 22040-0747, US

(21) Appl. No.: 10/003,069

(22) Filed: Dec. 6, 2001

(30) Foreign Application Priority Data
Dec. 6, 2000 (JP) 2000-371676(P)

(51) Int. Cl. G06F 17/60

(52) U.S. Cl. 707/500; 705/27

(57) ABSTRACT

A transfer terminal transferring information through a storage medium is separately provided for a game terminal executing a game. The transfer terminal communicates with a server, for example, through a data communication path. When an acquisition request for additional data related to a game program is transmitted from the transfer terminal to the server, the server transmits the additional data together with advertisement data related to the game program. The transfer terminal receives the contents transmitted from the server and writes to the storage medium. Thereafter, the storage medium is mounted on the game terminal and accessed, so that the additional data and the advertisement data are supplied to the game terminal. When the user executes the game using the additional data by operating the game terminal, advertisement image based on the supplied advertisement data is displayed for the user.

### BACKGROUND OF THE INVENTION

1. Field of the Invention

The present invention relates to an information processing apparatus, a communication apparatus, an information processing terminal, an information supplying apparatus, an information supplying method, an information supplying system and a computer readable recording medium. More specifically, the present invention relates to an information processing apparatus, a communication apparatus, an information processing terminal, an information supplying apparatus, an information supplying method, an information supplying system and a computer readable recording medium, for supplying desired information together with advertisement information related to the desired information, to a client.

2. Description of the Background Art

Various programs that can be executed by a computer including a game program as well as data of music and video images are sold stored in storage media such as CD-ROM (Compact Disc Read Only Memory) and DVD (Digital Versatile Disc). A game system improving diversity of game development by additionally storing distributed data to contents already stored in the storage medium is disclosed in Japanese Patent Laying-Open No. 8-173634.

According to this laid-open application, contents such as a program or data are prepared in advance in a server apparatus, the contents are downloaded to a client terminal through a network such as the Internet, and the contents are additionally written to the storage medium prepared on the side of the client terminal.

According to the technique described in the laid-open application, when the data to be added to the stored contents of the storage medium is distributed, advertising information related to the contents corresponding to the distributed data is not distributed. Therefore, it is impossible for a user to receive and view advertisement information related to the latest game program. It is impossible for a provider of the advertisement information (hereinafter referred to as an advertiser) either, to provide on real time basis, to a user who wishes to obtain the latest advertisement information.

Conventionally, advertisement information has been generally provided by an advertiser through magazines, television, newspapers and the like, uniformly to general public.

It is possible for a user to confirm advertisement information provided through magazines, television, newspaper and the like, before purchasing the latest contents. When the user wishes to continuously obtain information related to the purchased contents, it is necessary for the user to see whether corresponding advertisement information is presented or not on magazines, television, newspapers and the like.

As another method of obtaining advertisement information other than magazines, television, newspaper and the like, a post card for user registration attached to the purchased contents is used. Specifically, a purchaser of the contents writes prescribed information on the post card and sends the post card back to the distributer of the contents. The distributer registers the information of the user based on the described contents on the received post card. The distributer prepares a pamphlet or the like, for example, on which advertisement information of the contents purchased by the user are printed, and sends it (by mail) to the registered user of the contents.

Use of a post card for user registration requires the advertiser of time, labor and money in connection with preparation and sending of pamphlets and the like on which advertisement information is printed. It takes a few days for the user to obtain the desired advertisement information of the contents. When the information registered by using the post card for user registration is changed, it is necessary for the user to again perform the registration process if further advertisement information is desired, and it becomes impossible for the advertiser to send the advertisement information of the user whose information has been changed.

### SUMMARY OF THE INVENTION

An object of the present invention is to provide an information processing apparatus, a communication apparatus, an information processing terminal, an information supplying apparatus, an information supplying method, an information supplying system and a computer readable recording medium, that can provide desired information together with advertisement information related to the information, to the user.

In order to attain the above described object, according to an aspect, the present invention provides an information processing apparatus, including: an information receiving unit receiving externally supplied desired information together with advertisement data related to the desired information; processing portion for executing a prescribed process on the desired information received by the information receiving unit; and advertisement presenting portion for presenting, when the prescribed process is executed by the processing portion, an advertisement based on the advertisement data received by the information receiving unit.

The above described presentation of the advertisement encompasses image display or voice output through a speaker, of the contents of the advertisement to the user.

Therefore, in the information processing apparatus, the desired information together with the advertisement data related to the desired information are externally received by the information receiving unit, and when a prescribed process is executed by the processing portion, the advertisement based on the received advertisement data is presented by the advertisement presenting portion.

Therefore, it is possible for the user to surely obtain and confirm the advertisement related to the desired information, without the necessity of performing information registration operation to obtain the advertisement. Further, it is possible for the advertisement provider to surely and efficiently supply and present advertisement information to the target user without any limitation of time and space, even when information related to the user who wishes to obtain the advertisement information is not registered. Further, it is possible to eliminate the work and cost for information registration of the user, as well as the work and cost for advertisement through printing.

In the information processing apparatus described above, the information receiving unit includes a storage medium mounting unit to which an information storage medium storing in advance the desired information and the advertisement data is detachably mounted, and a storage medium reading unit reading the desired information together with the advertisement data related to the desired information, from the information storage medium mounted on the storage medium mounting unit.

Therefore, in the information processing apparatus, the desired information and the advertisement data related to the desired information are supplied, read from the information storage medium that stores the desired information and the advertisement data in advance.

Accordingly, part of the price of the storage medium storing the desired information can be absorbed by the advertiser presenting the advertisement data stored in the storage medium. Therefore, the sales price of the storage medium can be reduced. This makes it easier for the user to purchase the storage medium storing the desired information. Further, the advertiser can have increased chance to present the advertisement data.

In the information processing apparatus described above, the desired information includes additional data corresponding to a type to be added as an object of the prescribed process by the processing means.

Therefore, when additional data corresponding to the type that is to be added as the object of a prescribed processing by the processing means is supplied, the advertisement data is again supplied, and therefore, the chance for the user to obtain and confirm the advertisement data is increased. Further, the chance to supply and present the advertisement data to the user is also increased for the advertiser.

In the above described information processing apparatus, the information receiving unit has a communication unit for communication with the outside through a communication path, and receiving portion for receiving, through the communication unit, the externally transmitted desired information and the advertisement data related to the desired information.

Therefore, in the information processing apparatus, the desired information and the advertisement data related to the desired information are supplied, received externally through a communication path.

By using the communication path, it becomes possible for the user to obtain and confirm advertisement data related to the desired information, without any limitation in time and space. Further, it becomes possible for the advertiser to supply and present the advertisement data related to the desired information to the user through the communication path, without any limitation in time and space.

In the above described information processing apparatus, the information receiving unit includes additional data specifying portion for specifying type of the additional data, based on execution result of the prescribed process by the processing portion, additional data requesting portion for transmitting to the outside through the communication unit a request for acquiring the additional data corresponding to the type specified by the additional data specifying portion, and data receiving portion for receiving from the outside through the communication unit, the advertisement data and the additional data of the type corresponding to the acquisition request transmitted by the additional data requesting portion.

Therefore, in addition to the additional data of the type specified based on the result of execution of the prescribed processing by the processing portion, the advertisement data is supplied to the information processing apparatus. Therefore, it is possible for the user to obtain at a desired frequency, the additional data of the type corresponding to the result of execution of the prescribed process and the advertisement data.

In the above described information processing apparatus, the acquisition request includes advertisement specifying data for specifying the advertisement data, and the data receiving portion receives the advertisement data specified by the advertisement specifying data included in the acquisition request transmitted by the additional data requesting portion.

Therefore, in the information processing apparatus, the advertisement based on the advertisement data specified by the advertisement specifying data is presented. Therefore, it is possible for the user to receive and confirm the advertisement data without any necessity of specially designating the advertisement data.

The advertisement identification data mentioned above refers to data that can specify the advertiser supplying the advertisement data.

The above described information processing apparatus is portable.

Therefore, it is possible for the user to obtain the desired information or additional data, together with the advertisement data, while the user is on the road with the portable information processing apparatus. Therefore, it is possible to obtain and confirm the advertisement data, at any time, any place.

According to another aspect, in order to attain the above described object, the present invention provides a communication apparatus, including: a communication unit communicating with an external information supplying unit through a communication path; receiving portion receiving, through the communication unit, externally transmitted desired information for executing a prescribed process, and advertisement data related to the desired information; a storage medium mounting unit on which a storage medium is detachably mounted; and a storage medium writing unit writing the desired information and the advertisement data received by the receiving portion to the storage medium mounted on the storage medium mounting unit.

Therefore, in the communication apparatus, when the external information together with the advertisement data related to the desired information are received externally by the receiving portion, the received information and the data are written to the mounted storage medium, by the storage medium writing unit.

Therefore, it is possible for the user of the communication apparatus to surely obtain the advertisement related to the desired information, through the storage medium, without the necessity of performing information registration operation to obtain the advertisement. Further, it is possible for the advertiser to surely and efficiently supply and present advertisement information to the target user, without any limitation of time and space, even when information related to a user who wishes to have the advertisement information is not registered in advance. Further, the work and cost for registering information related to the user and the work and cost for advertisement through printing can be eliminated.

In the storage medium of the communication apparatus described above, the storage medium stores in advance information specifying data for specifying the desired information and advertisement specifying data for specifying the advertisement data. The communication apparatus further includes: reading portion for reading the information specifying data and the advertisement specifying data from the storage medium mounted on the storage medium mounting unit; and request transmitting portion for transmitting, through the communication unit, an acquisition request for the desired information and the advertisement data, using the information specifying data and the advertisement specifying data read by the reading portion; wherein the receiving portion receives the desired information and the advertisement data specified by the information specifying data and the advertisement specifying data transmitted by the request transmitting portion.

Therefore, in the communication apparatus, the desired information and the advertisement data specified by the information specifying data and advertisement specifying data stored in advance in the storage medium are received from external information supplying unit and written to the storage medium.

Therefore, when the desired information and the advertisement data specified by the information specifying data and the advertisement specifying data stored in advance in the storage medium are transmitted and supplied from an external information supplying unit, it is possible for the user of the communication apparatus to obtain the information by writing the information to the storage medium.

In the communication apparatus, the storage medium stores in advance connection destination data for specifying and connecting to the information supplying unit; and the communication unit communicates with the information supplying unit based on the connection destination data stored in the storage medium mounted on the storage medium mounting unit.

Therefore, based on the connection destination data stored in the storage medium, the supply destination of the desired information and the advertisement data can be uniquely identified and connection can be established automatically. Therefore, the user is free of any troublesome operation of connection.

In the communication apparatus described above, the desired information includes additional data to be added as an object of the prescribed process.

Therefore, every time the additional data is received and written to the storage medium, the advertisement data is also received and written to the storage medium. Therefore, the user of the communication apparatus can obtain the advertisement data frequently, through the storage medium. Further, it is possible for the advertiser to supply more frequently the advertisement data to the user.

According to a still further aspect, in order to attain the above described object, the present invention provides an information processing terminal, including: a storage medium reading unit reading, from a storage medium storing desired information and advertisement data related to the desired information, the desired information and the advertisement data; processing portion for executing a prescribed process on the desired information read by the storage medium reading unit; and advertisement presenting portion for presenting, when the prescribed process is executed by the processing portion, the advertisement data read by the storage medium reading unit.

Therefore, in the information processing apparatus, when the desired information and the advertisement data related to the desired information are read from the storage medium, prescribed processing is executed on the desired information by the processing portion and the advertisement data is presented by the advertisement presenting portion.

Therefore, the user of the information processing terminal can obtain and confirm the desired information together with the related advertisement data.

The information processing terminal described above further includes a storage medium mounting unit to which the storage medium is detachably mounted; wherein the storage medium reading unit performs reading of the storage medium mounted on the storage medium mounting unit.

Therefore, a plurality of different storage media can be detachably and alternately mounted to the information processing terminal. Therefore, it is possible to obtain a plurality of different pieces of desired information as well as a plurality of different advertisement data.

In the above described information processing terminal, the desired information includes additional data corresponding to a type to be added as an object of the prescribed process by the processing portion.

Therefore, it is possible for the user of the information processing terminal to obtain the advertisement data, every time he/she obtains additional data.

In the above described information processing terminal, the type of the additional data is specified based on execution result of the prescribed process by the processing portion.

Therefore, when additional data corresponding to the type based on the result of execution of the prescribed process by the processing portion is supplied, it is possible for the user of the information processing terminal to perform the prescribed process using the additional data, providing diversity in the contents of execution of the prescribed process.

The information processing apparatus is portable.

Therefore, it is possible for the user to execute the prescribed process at any place, and to present and confirm the advertisement data, while he/she is on the road with the portable information processing terminal.

According to a still further aspect, in order to attain the above described object, the present invention provides an information supplying apparatus includes: acquisition request receiving portion for receiving an acquisition request for a desired information; and data supplying portion responsive to reception of the acquisition request by the acquisition request receiving portion, for transmitting the desired information together with advertisement data related to the desired information, to a source of the acquisition request.

Therefore, to the user as the request source, the desired information and the advertisement data related to the desired information are supplied through communication from the information supplying apparatus, and the supplied advertisement data is presented to the user.

Therefore, it is possible for the user to surely obtain and confirm the advertisement related to the desired information, without the necessity of performing information registration operation to obtain the advertisement. Further, it is possible for the advertiser to efficiently supply and present the advertisement data to the target user without any limitation of time and space through the information supplying apparatus, even when information related to the user who wishes to obtain the advertisement data is not registered. Further, conventional work and cost for registering information related to the user and work and cost for advertisement through printing can be eliminated.

In the information supplying apparatus described above, the desired information includes additional data corresponding to a type to be added as an object of information processing executed by the source of acquisition request.

In the information supplying apparatus described above, the acquisition request includes type data representing type of the additional data. The information supplying apparatus further includes an additional data storing unit storing a plurality of different the additional data. The data supplying portion transmits, in response to reception of the acquisition request by the acquisition request receiving portion, the additional data read from the additional data storing unit based on the type data in the received acquisition request to the source of acquisition request.

Therefore, the user as the request source has increased chance to obtain and confirm the advertisement data, as the advertisement data is supplied and presented when additional data corresponding to the type to be added as the object of prescribed processing is supplied. Further, it is possible for the advertiser to increase the chance to supply and present the advertisement data to the user.

In the information supplying apparatus described above, the acquisition request includes advertisement specifying data for specifying the advertisement data. The information supplying apparatus further includes an advertisement data storing unit storing a plurality of different the advertisement data. The data supplying portion transmits, in response to reception of the acquisition request by the acquisition request receiving portion, the advertisement data read from the advertisement data storing unit based on the advertisement specifying data in the received acquisition request, to the source of request.

Therefore, the type of the advertisement data supplied and presented to the user as the request source can be designated by using the identification data in the acquisition request.

In the information supplying apparatus described above, the advertisement data storing unit stores the advertisement data corresponding to a plurality of advertisers supplying the advertisement data. The advertisement specifying data is data for specifying the advertiser.

Therefore, the advertisement data supplied and presented to the user as the request source can be designated by using the identification data for specifying the advertiser in the acquisition request. Therefore, it is possible for the user to obtain the desired advertisement data from the advertiser presenting the desired advertisement data, without any operation to specify the advertiser.

In the above described information supplying apparatus, the advertisement data in the advertisement data storing unit is registered and updated by corresponding the advertiser.

Accordingly, the advertisement data of the advertisement data storing unit in the information supplying apparatus is constantly updated to be the latest contents by the corresponding advertiser, and therefore, the advertisement data of the latest contents can be supplied and presented to the user as the request source.

In the above described information supplying apparatus, each of the plurality of different additional data in the additional data storing unit are registered and updated by the data supplier supplying the additional data.

Therefore, the additional data in the additional data storing unit of the information supplying apparatus is constantly updated to be the latest contents by the corresponding data supplier, and therefore additional data of the latest contents can be supplied to the user as the request source.

According to a still further aspect, in order to attain the above described object, the present invention provides, in an information processing system including a plurality of terminals executing a prescribed process on a desired information and presenting supplied data, and an information supplying apparatus communicating with an arbitrary one of the plurality of terminals for supplying information to the arbitrary terminal, a method of supplying information, including the steps of: transmitting an acquisition request for the desired information from the arbitrary terminal to the information supplying apparatus; and in response to reception of the acquisition request transmitted in the step of transmitting the acquisition request, supplying the desired information together with advertisement data related to the desired information by transmitting from the information supplying apparatus to the arbitrary terminal.

Therefore, in the information supplying method, the desired information transmitted by the information supplying apparatus and the advertisement data related to the desired information are received by an arbitrarily terminal and thus supplied, so that the prescribed processing is executed on the supplied desired information, and the advertisement based on the supplied advertisement data is presented to the user of the arbitrary terminal.

Therefore, it is possible for the user to surely obtain and confirm the advertisement data related to the desired information, without the necessity of performing information registration operation to obtain the advertisement. Further, it is possible for the advertiser to surely and efficiently supply and present the advertisement data to the target user, without any limitation of time and space, even when the information related to the user who wishes to obtain the advertisement data is not registered. Further, the conventional work and cost for registering information related to the user and the work and cost of advertisement through printing can be eliminated.

According to a still further aspect, in order to attain the above described object, the present invention provides an information supplying system including a plurality of terminals executing a prescribed process on desired information and presenting supplied data, and an information supplying apparatus communicating with an arbitrary one of the plurality of terminals for supplying information to the arbitrary terminal, including: acquisition request transmitting portion for transmitting an acquisition request of the desired information from the arbitrary terminal to the information supplying apparatus; and data supplying portion responsive to reception of the acquisition request transmitted by the acquisition request transmitting portion, for transmitting and supplying the desired information together with advertisement data related to the desired information, from the information supplying apparatus to the arbitrary terminal.

Accordingly, in the information supplying system, the desired information transmitted from the information supplying apparatus as well as the advertisement data related to the desired information are received at, and thereby supplied to the arbitrarily terminal, and the prescribed processing is executed on the supplied desired information, and the advertisement based on the supplied advertisement data is presented to the user of the arbitrarily terminal.

Therefore, it is possible for the user to surely obtain and confirm the advertisement data related to the desired information, without the necessity of performing an information registration operation to obtain the advertisement. It is possible for the advertiser to surely and efficiently supply and present the advertisement data to the target user without any limitation of time and place, even when information related to the user who wishes to obtain the advertisement data is not registered. Further, conventional work and cost for registering information related to the user and the work and cost for advertisement through printing can be eliminated.

According to a still further aspect, in order to attain the above described object, the present invention provides a computer readable recording medium, including: a program information storing unit storing program information for executing a desired information processing: an additional data storing unit storing additional data related to the program information read together with the program information for executing the desired information processing; and an advertisement storing unit storing advertisement data related to the program information, read to be presented when the desired information processing is executed.

Therefore, when the program information or additional data are read from the recording medium and prescribed information processing is executed based thereon, the advertisement data related to the program information is always read and presented.

Therefore, it is possible for the user to obtain and confirm the advertisement data related to the program information of the desired information processing, without the necessity of performing information registration operation to obtain the advertisement data. It is possible for the advertiser to surely present the advertisement data to the target user, without the necessity of registering information related to the user who wishes to obtain the advertisement data. Further, conventional work and cost for obtaining and registering information related to the user and the work and cost for advertisement through printing can be eliminated.

The recording medium described above further includes advertisement specifying data storing unit storing advertisement specifying data for specifying the advertisement data; wherein the advertisement data specified by the advertisement specifying data is externally supplied and stored in the advertisement storing unit.

Therefore, when the advertisement data is externally supplied, the advertisement data is presented to the user through the recording medium.

In the recording medium described above, the program information includes identification information for storing identification information for uniquely identifying the additional data; wherein the additional data specified by the identification information is externally supplied and stored in the additional data storing unit.

In the recording medium described above, the additional data includes next order identification information for uniquely identifying the additional data to be added next, and the additional data specified by the next order identification information is externally supplied and stored in the additional data storing unit.

Therefore, the desired information processing is executed while the externally supplied additional data is added to the program information through the recording medium. As the additional data, identification information of next order additional data or next order identification information is included in the program information or additional data. Therefore, area management becomes easier than when the identification information or next order identification information related to the storage medium is stored in individual areas. Further, when the additional data is stored, the next order identification information is also stored automatically, and therefore, efficient access to such information is possible.

The recording medium described above further includes a connection destination information storing unit storing connection destination information to specify the supply source and to establish communication therewith.

Therefore, using the read connection destination information, it is possible to externally receive and store the additional data or advertisement data mentioned above.

The above described recording medium further includes an execution result storing unit storing the result in the middle or at the end of execution, when the desired information processing is executed.

Therefore, based on the contents stored in the execution result storing unit, the desired information processing can be resumed or started from the middle of or at the end of execution.

In the execution result storing unit of the above described recording medium, one of identification information and next order identification information is stored as the execution end result of the prescribed information processing into the execution result storing unit.

Therefore, when the desired information processing is executed and terminated, additional data based on the content stored in the execution result storing unit is supplied and stored, whereby the desired information processing using the additional data can be executed. Therefore, every time the additional data is supplied, the contents of processing to be executed can be varied.

The advertisement specifying data in the computer readable recording medium described above is the data for specifying the advertiser.

Therefore, the advertisement data supplied by the advertiser is recorded on the recording medium, with the advertiser specified.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a schematic configuration of the information communication system in accordance with the first embodiment of the present invention.

FIGS. 2A and 2B represent internal configuration and appearance of a storage medium 400 in accordance with the first embodiment.

FIGS. 3A to 3C are illustrations showing part of the contents stored in the storage medium 400 in accordance with the first embodiment.

FIG. 4 shows a configuration of a server in accordance with the first embodiment.

FIGS. 5A and 5B represent specific examples of the contents in an advertisement data storing unit 120 and an additional data storing unit 130 of FIG. 4.

FIG. 6 shows an appearance of the server in accordance with the first embodiment.

FIG. 7 shows a hardware configuration of the server in accordance with the first embodiment.

FIG. 8 shows a configuration of a terminal 200 in accordance with the first embodiment.

FIG. 9 shows a configuration of a terminal 500 in accordance with the first embodiment.

FIGS. 10A to 10E are examples of the images displayed when a game is executed at the terminal 500 in accordance with the first embodiment.

FIG. 11 is a process flow chart when an application 401A is executed, purchasing a storage medium 400, at a terminal 500 in accordance with the first embodiment.

FIG. 12 is a flow chart of a data transfer process between terminal 200 and a prescribed server, in accordance with the first embodiment.

FIG. 13 is a process flow chart when the game execution is resumed, after additional data 402A is transferred, in accordance with an embodiment of the present invention.

### DESCRIPTION OF THE PREFERRED EMBODIMENTS

Embodiments of the present invention will be described with reference to the figures.

The information communication system in accordance with its embodiment employs a server client system configuration, in which the server transmits and supplies desired contents and advertisement data related to the desired contents to the client, in response to a request from the client. Here, computer game programs and data will be described here as examples of the contents. However, the contents are not limited thereto. For example, the contents may be continuous data of novels, movies, dramas and music.

First Embodiment

The first embodiment will be described. In the first embodiment, a process will be described in which a server transmits and supplies contents and advertisement data related to the contents, to a client.

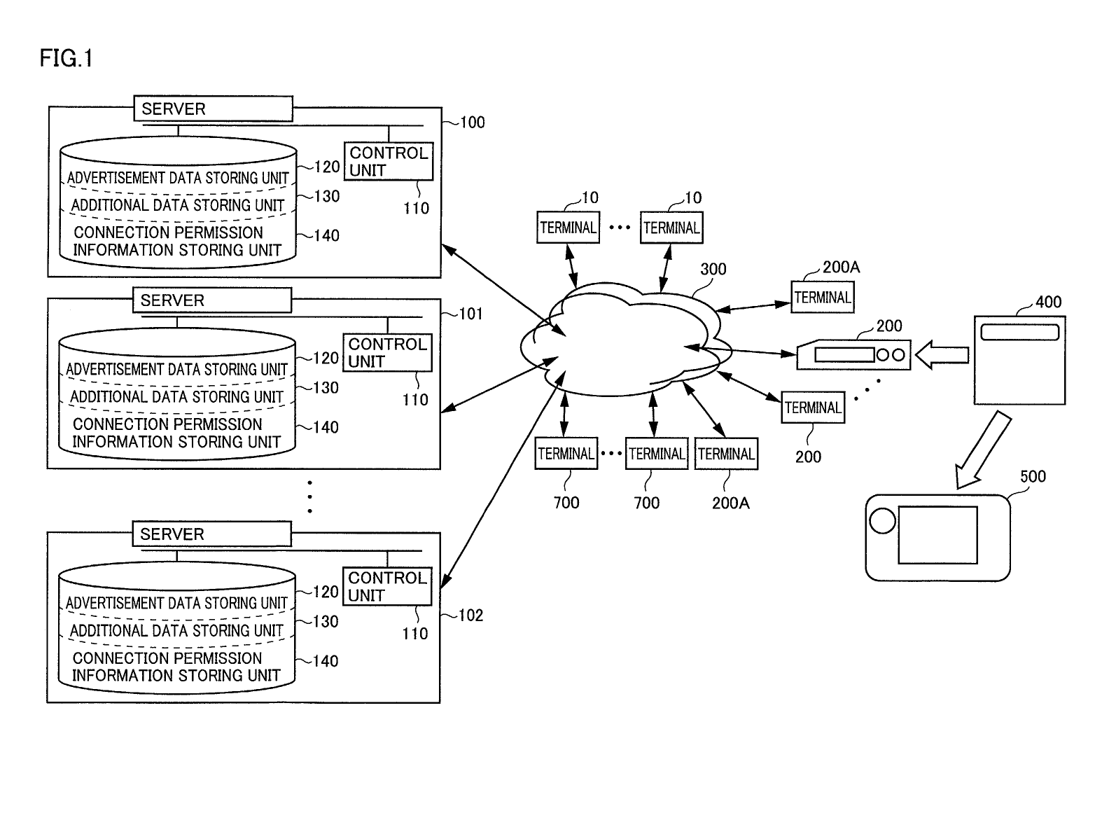

FIG. 1 shows a schematic configuration of the information communication system in accordance with the present embodiment. Referring to FIG. 1, the information communication system includes a data communication path 300, servers 100 to 102 connected to data communication path 300, one or more terminals 200, one or more terminals 200A, one or more terminals 10 and one or more terminals 700. Each of the terminals 10 is provided corresponding to an advertiser supplying advertisement data to the information communication system. Each of the terminals 700 is provided corresponding to a data supplier, for example, a content producing company, supplying additional data, which will be described later, related to the contents, to the information communication system. Terminals 10 and 700 have the function of a computer. Terminals 200 and 200A are provided corresponding to respective clients. The information communication system further includes a storage medium 400 and a terminal 500 related to each of terminals 200. Storage medium 400 is detachably mounted from the outside of terminal 200. Storage medium 400 is also detachably mounted to terminal 500.

Terminal 200A is formed to have functions of both terminals 200 and 500.

For simplicity of description, communication between one terminal 200 among at least one terminal 200 connected to data communication path 300 and servers 100 to 102 will be considered.

Servers 100 to 102 each have the same structure, and include a control unit 110 for centralized management and control of the server itself, an advertisement data storing unit 120, an additional data storing unit 130, and a connection permission information storing unit 140.

Data communication path 300 includes, but is not limited to, the Internet, LAN (Local Area Network), telephone circuit or mobile communication network bidirectionally connecting servers 100 to 102, terminals 200 and terminals 10 and 700 for communication.

Storage medium 400 is a disc covered by a hard cover of resin material. Terminal 200 has a function of reading or writing the contents stored in the mounted storage medium 400. Terminal 500 has a function of a computer executing a prescribed operation based on the contents stored in the mounted storage medium 400. Here, a portable game machine is considered.

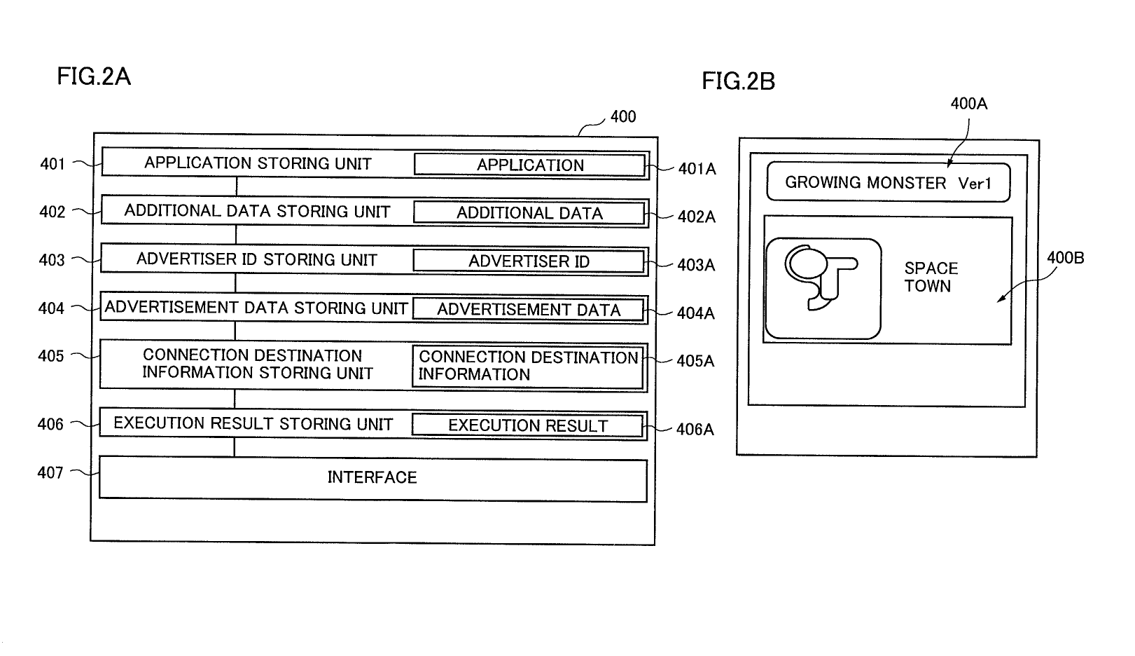

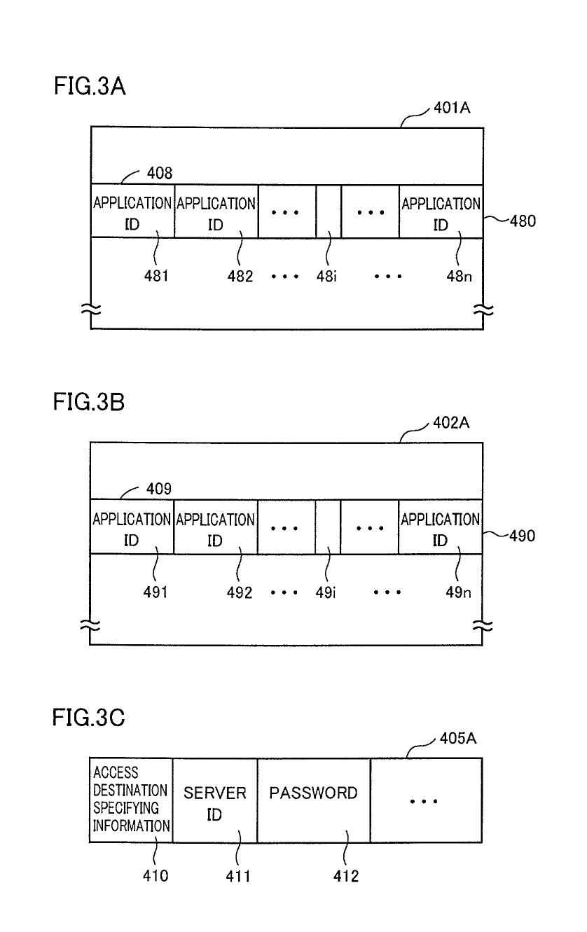

FIGS. 2A and 2B represent internal configuration and appearance of the storage medium 400 in accordance with the present embodiment. FIGS. 3A to 3C represent part of the contents stored in storage medium 400 in accordance with the present embodiment. Referring to FIG. 2B, on the surface of a cover formed of resin material covering storage medium 400, a product name label 400A and an advertisement label 400B are sticked, on which product name and advertisement data are printed, respectively. The product name represented by product name label 400A is the name of the game program stored in advance in storage medium 400. The advertisement data represented by advertisement label 400B represent information related to advertisement for sales promotion of the game program.

Referring to FIG. 2A, storage medium 400 has an application storing unit 401 storing an application 401A; an additional data storing unit 402 that can store additional data 402A; an advertiser ID (identification) storing unit 403 storing an advertiser ID 403A; an advertisement data storing unit 404 that can store advertisement data 404A; a connection destination information storing unit 405 storing connection destination information 405; an execution result storing unit 406 storing execution result 406A; and an interface 407.

Application 401A corresponds to the game program (including data referred to while executing the program) that can be executed by itself on terminal 500, and as shown in FIG. 3A, includes data 408 of application 401A and application ID information 480. Application ID information 480 includes a plurality of different application IDs 48i (i=1, 2, 3, . . . , n). When a process in accordance with the data 408 of application 401A is executed by terminal 500, one application ID 48i among application ID information 480 is selected based on the corresponding information of execution result at the end of execution, and the selected application ID 48i is stored as execution result 406A in execution result storing unit 406. Based on application ID 48i stored as execution result 406A, the selected additional data 402A is stored in additional data storing unit 402.

At the time of purchasing the storage medium 400, nothing is stored in additional data storing unit 402. The additional data 402A is stored afterwards.

Additional data 402A includes, as shown in FIG. 3B, added data 409 and application ID information 490. Application ID information 490 includes a plurality of different application IDs 49i (i=1, 2, 3 . . . , n). Using data 409 of additional data 402A, a process in accordance with data 408 of application 401A is executed by terminal 500. At the end of execution of the process, one application ID 49i is selectively read from application ID information 490 based on the result of execution, and stored as execution result 406A in execution result storing unit 406. The application ID 49i stored as execution result 406A represents information for specifying additional data 402A to be stored next in the additional data storing unit 402.

In advertisement data storing unit 404, advertisement data 404A is stored in advance, when the storage medium 400 is purchased. Advertisement data 404A represents information of advertisement related to application 401A and additional data 402A to be stored in storage medium 400. Advertisement data 404A in advertisement data storing unit 404 is rewritten and updated every time the advertisement data 404A is supplied.

In advertiser ID storing unit 403, an advertiser ID 403A is stored when storage medium 400 is purchased. Advertiser ID 403A represents information for identifying the advertiser supplying the corresponding advertisement data 404A. The advertiser identified by advertiser ID 403A may correspond to the distributor or manufacturer of the corresponding application 401A or additional data 402A.

Connection destination information storing unit 405 stores in advance, the connection destination information 405A for connecting to any one of servers 100 to 102, when storage medium 400 is purchased. Connection destination information 405A represents information for specifying and connecting to a server supplying the corresponding additional data 402A, and the information includes access destination specifying information 410 for accessing to a prescribed server, a server ID 411 for identifying the server, and a password 412 for connection to the server, as shown in FIG. 3C.

The execution result 406A in execution result storing unit 406 corresponds to one of the application IDs 48i selected from application ID information 480 or an application ID 49i selected from application information 490, or the result in the middle of the execution using application 401A, as already described.

Interface 407 is an interface mounting storage medium 400 to terminal 200 or 500, so as to enable access by the terminal 200 or 500 to the stored contents thereof.

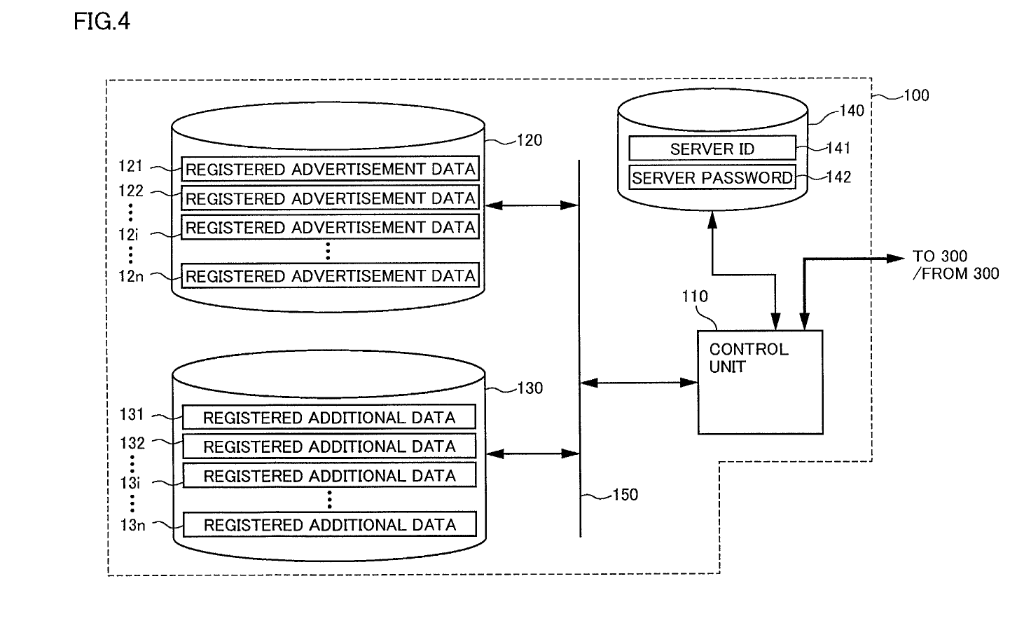

FIG. 4 shows a configuration of the server in accordance with the present embodiment. As the servers in accordance with the present invention have similar structures, a server 100 shown in FIG. 1 will be described here. Referring to FIG. 4, server 100 includes control unit 110 connected to data communication path 300, for centralized control and management of the server itself; advertisement data storing unit 120 and additional data storing unit 130 connected to control unit 110 through a bus 150; and connection permission information storing unit 140 directly connected to control unit 110. Data communication path 300, advertisement data storing unit 120, additional data storing unit 130 and connection permission information storing unit 140 are each connected bidirectionally to control unit 110.

In advertisement data storing unit 120, a plurality of different registered advertisement data 12i (i=1, 2, 3, . . . , n) to be stored in the storage medium 400 as the above described advertisement data 404A are stored. In additional data storing unit 130, a plurality of different registered additional data 13i (i=1, 2, 3 . . . , n) to be stored in the storage medium 400 as the above described additional data 402A are stored in advance. In connection permission information storing unit 140, server ID 141 and server password 142 are stored in advance. Server ID 141 and server password 142 represent information uniquely allocated to the server 100, which are compared with the server ID 411 and password 412 mentioned above. When these match with each other, access to the data stored in advertisement data storing unit 120 and additional data storing unit 130 is permitted.

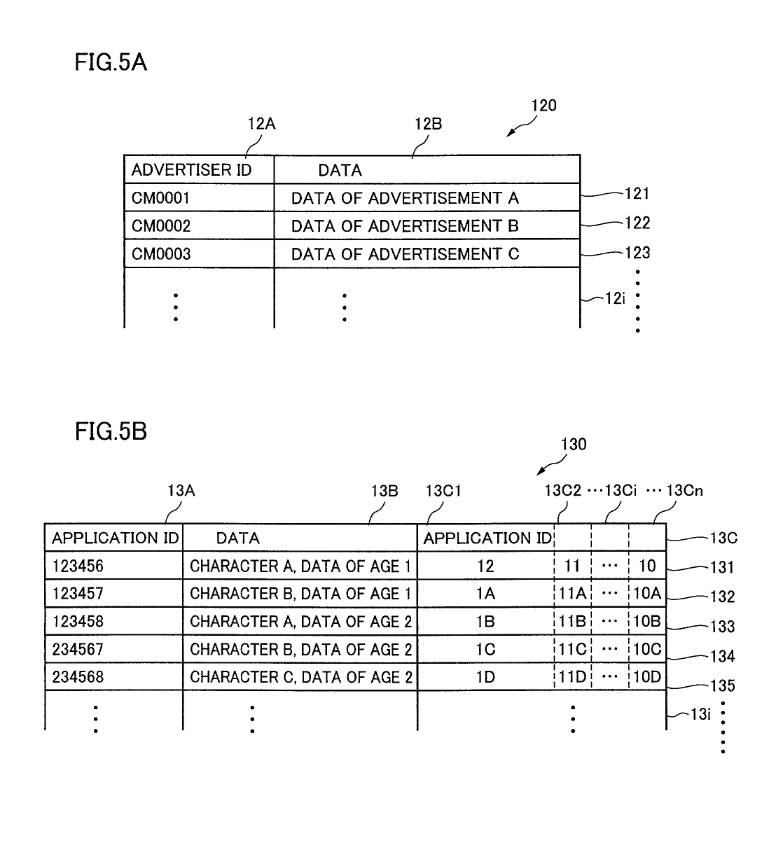

FIGS. 5A and 5B represent specific examples of the content in advertisement data storing unit 120 and additional data storing unit 130 of FIG. 4. In advertisement data storing unit 120 of FIG. 5A, a plurality of different registered advertisement data 12i including advertiser ID 12A and data 12B are stored. Data 12B represent data for advertisement that is daily updated by the advertiser to which the corresponding advertiser ID 12A is allocated. The procedure for the update will be described later. Here, it is assumed that data 12B of advertisement data 12i is updated upon request of the advertiser.

Referring to FIG. 5B, in additional data storing unit 130, a plurality of different registered additional data 13i are stored, which include application ID 13A, data 13B and application ID information 13C. Application ID 13A represent information for uniquely identifying the corresponding data 13B. Data 13B represent data to be arbitrarily added with respect to application 401A stored in application storing unit 401 of storage medium 400, and represents information that provides variation in the contents to be processed, when the process of the corresponding application 401A is executed by terminal 500. For example, it represents character information of the characters appearing in the game played by the terminal 500, or information for providing variety in the background information on which the characters appear. Application ID information 13C includes a plurality of different application IDs 13Ci (i=1, 2, 3, . . . , n). Application ID 13Ci represent information for specifying data to be added next in accordance with the execution result, when the process in accordance with application 401A using the corresponding registered additional data 13i is executed by terminal 500.

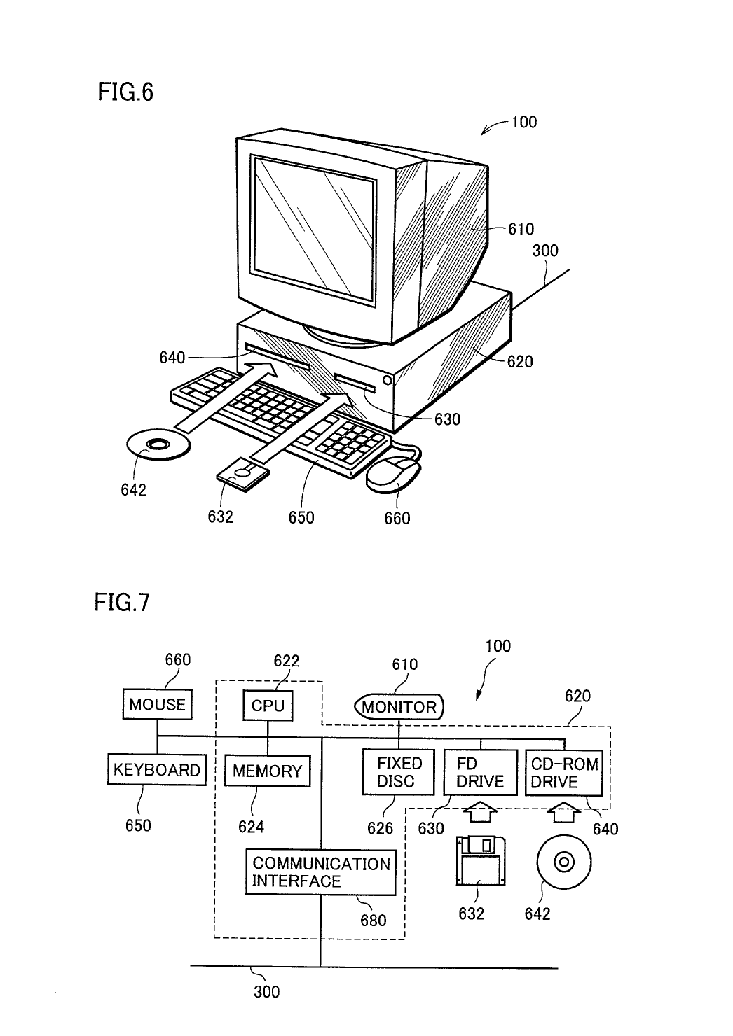

FIGS. 6 and 7 represent appearance and hardware configuration of the server in accordance with the present embodiment.

Referring to FIGS. 6 and 7, server 100 has a function of a computer, and has a processing unit 620, a monitor 610 of a CRT (Cathode Ray Tube) or the like, a keyboard 650 and a mouse 660. Processing unit 620 includes: a CPU (Central Processing Unit) 622 for centralized control of the computer itself; a memory 624 including an ROM or an RAM (Random Access Memory); a fixed disc 626; an FD drive 630 to which an FD (Flexible Disc) 630 is detachably mounted, for accessing to the mounted FD 632; a CD-ROM (Compact Disk Read-Only Memory) drive 640 to which a CD-ROM 642 is detachably mounted, for accessing to the mounted CD-ROM 642; and a communication interface 680 for connecting the server 100 to data communication path 300 for communication. These units are connected for communication through a bus. Server 100 may be provided with a magnetic tape drive to which a cassette type magnetic tape is detachably mounted, for accessing to the magnetic tape.

The control unit 110 described above corresponds to CPU 622 and memory 624, while advertisement data storing unit 120, additional data storing unit 130 and connection permission information storing unit 140 correspond to fixed disc 626.

FIG. 8 shows a configuration of each of the terminals 200 and 200A in accordance with the present embodiment. Referring to FIG. 8, terminal 200 and 200A each include: a communication path connecting unit 201; a temporary storage unit 202; a control unit 203; a display unit 204 formed of an LCD (Liquid Crystal Display) or the like; an operating unit 205 such as a keyboard for externally entering data; a storage medium read/write unit 206; and an interface 207. The terminals each have a function of a computer.

Communication path connecting unit 201 is connected to a prescribed server through data communication path 300, to establish bidirectional communication between the terminal and the prescribed server.

Temporary storage unit 202 temporarily stores the registered advertisement data 12i and registered additional data 13i transferred from the connected prescribed server. At a stage where transfer of the registered advertisement data 12i and registered additional data 13i from the prescribed server is completed, the registered advertisement data 12i and registered additional data 13i that have been stored in temporary storage unit 202 are written as advertisement data 404A and additional data 402A to advertisement data storing unit 404 and additional data storing unit 402 of storage medium 400 by storage medium reading/writing unit 206, respectively, as will be described later.

Control unit 203 is previously provided with a CPU 203A and a storage area 203B on which a control program for controlling the operation of the terminal is recorded. As CPU 203A executes the control program stored in storage area 203B, other portions are controlled.

Interface 207 represents a portion to which storage medium 400 is detachably mounted, for executing data transfer between the mounted storage medium 400 and the terminal.

Storage medium reading/writing unit 206 has a function of reading and writing the contents stored in the storage medium 400 mounted to interface 207. By the reading function, the connection destination information 405A stored in advance in connection destination information storing unit 405, any of application IDs 48i and 49i stored as execution result 406A in execution result storing unit 406 and advertiser ID 403A stored in advertiser ID storing unit 403 of storage medium 400 are read. By the writing function, the registered additional data 13i and registered advertisement data 12i stored in temporary storage unit 202 are written as additional data 402A and advertisement data 404A to additional data storing unit 402 and advertisement data storing unit 404 of storage medium 400, respectively.

If the terminal is not provided with temporary storage unit 202, by the writing function of storage medium reading/writing unit 206, the registered additional data 13i and registered advertisement data 12i received from the prescribed server through the communication path connecting unit 201 are directly written as additional data 402A and advertisement data 404A, to additional data storing unit 402 and advertisement data storing unit 404 of storage medium 400, respectively.

When terminal 200A is represented by the configuration of FIG. 8, advertisement data 404A and additional data 402A transferred from server 100 may be directly written to storage medium 400 mounted through interface 207. Further, control unit 203 displays advertisement image based on advertisement data 404A stored in storage medium 400 on display unit 204, while executing the game in accordance with the application 401A or additional data 402A stored in storage medium 400.

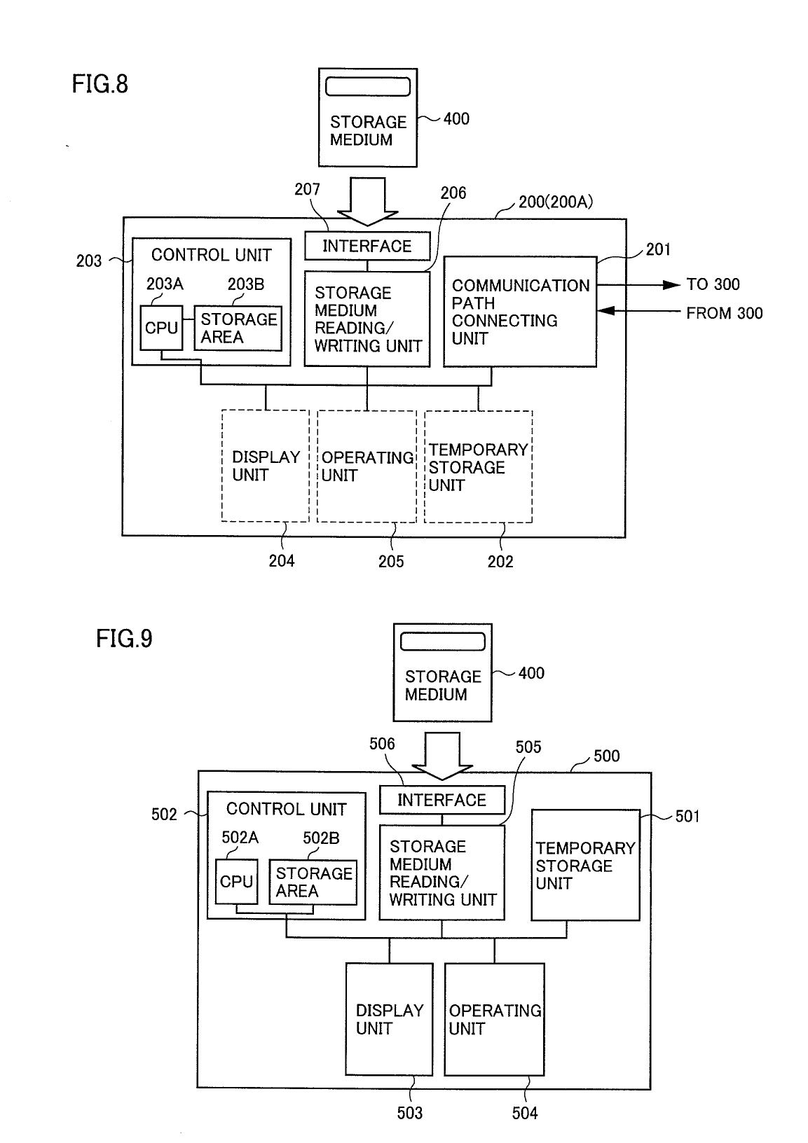

FIG. 9 shows a configuration of terminal 500 in accordance with the present embodiment. Here, terminal 500 represents a portable game machine, for example. Terminal 500 includes a temporary storage unit 501, a control unit 502, a display unit 503 of LCD (Liquid Crystal Display), an operating unit 504 including buttons, switches or the like, a storage medium reading/writing unit 505 and an interface 506. A voice output unit may be provided, though not provided in this example.

Storage medium 400 is detachably mounted to interface 506, and the interface enables access to the contents stored in the mounted storage medium 400 by the terminal 500.

Temporary storage unit 501 temporarily stores a result in the middle of execution or a final result of execution of the process in accordance with application 401A stored in application storing unit 401 of the mounted storage medium 400, as needed.

Storage medium reading/writing unit 505 has the function of reading and writing the stored contents of storage medium 400 mounted on interface 506. By the reading function, application 401A stored in application storing unit 401, additional data 402A stored in additional data storing unit 402 and advertisement data 404A stored in advertisement data storing unit 404 of storage medium 400 are read. By the writing function, the intermediate result or final result stored in temporary storage unit 501 in the middle of or at the end of execution of the process in accordance with application 401A stored in application storing unit 401 or additional data 402A stored in additional data storing unit 402 of storage medium 400 is written as execution result 406A, in execution result storing unit 406 of storage medium 400.

Control unit 502 has CPU 502A and storage area 502B, executes the process based on application 401A or additional data 402A read from storage medium 400 by storage medium reading/writing unit 505 in accordance with various data input through operating unit 504, so as to control various other portions and execute the game. The result in the middle of executing the game or the final result of the game is stored in the temporary storage unit 501.

Display unit 503 displays images (characters, pictures and the like) in accordance with the progress of the game, when the game is executed by control unit 502. Further, an image for advertisement based on advertisement data 404A read from the storage medium 400 by storage medium reading/writing unit 505 is also displayed. Operating unit 504 is externally operated by the user to apply various data necessary for the progress of the game when the game is executed, to control unit 502.

In the following, an example will be described in which a game of growing a virtual pet is played by the terminal 500, while additional data 402A and advertisement data 404A related to the game are supplied from a prescribed server through terminal 200 and storage medium 400 to terminal 500.

First, assume that a user purchases storage medium 400 in which the game software (program, data) is stored as application 401A in application storing unit 401 at a convenience store, a book store, or a toy store, and mounts the storage medium 400 to the interface 506 of terminal 500. Here, application 401A for the game is supplied to the user, as the user purchases the storage medium 400. The application may be supplied through other method. For example, application 401A may be downloaded to application storing unit 401 of storage medium 400 mounted on terminal 200 from the prescribed server through data communication path 300, the storage medium 400 to which application 401A has been downloaded is removed from terminal 200 and mounted to interface 506 of terminal 500, so that the user can be supplied with the game application 401A.

When the above described application 401A is supplied to the user by the purchase of storage medium 400 storing the application in advance, advertiser ID 403A, advertisement data 404A and connection destination information 405A are stored in advance in advertiser ID storing unit 403, advertisement data storing unit 404 and connection destination information storing unit 405 of the purchased storage medium 400, respectively.

When storage medium 400 storing application 401A is purchased or when application 401A is downloaded, data is not at all stored in additional data storing unit 402 and execution result storing unit 406 of storage medium 400.

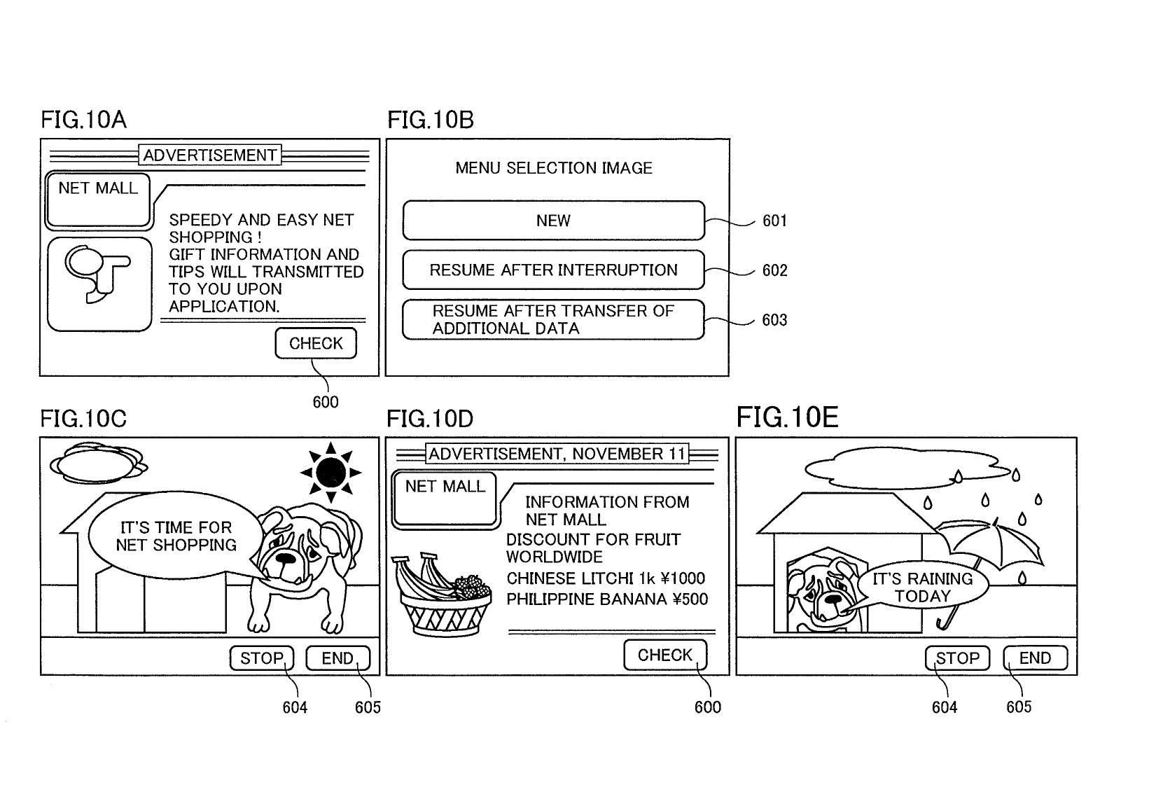

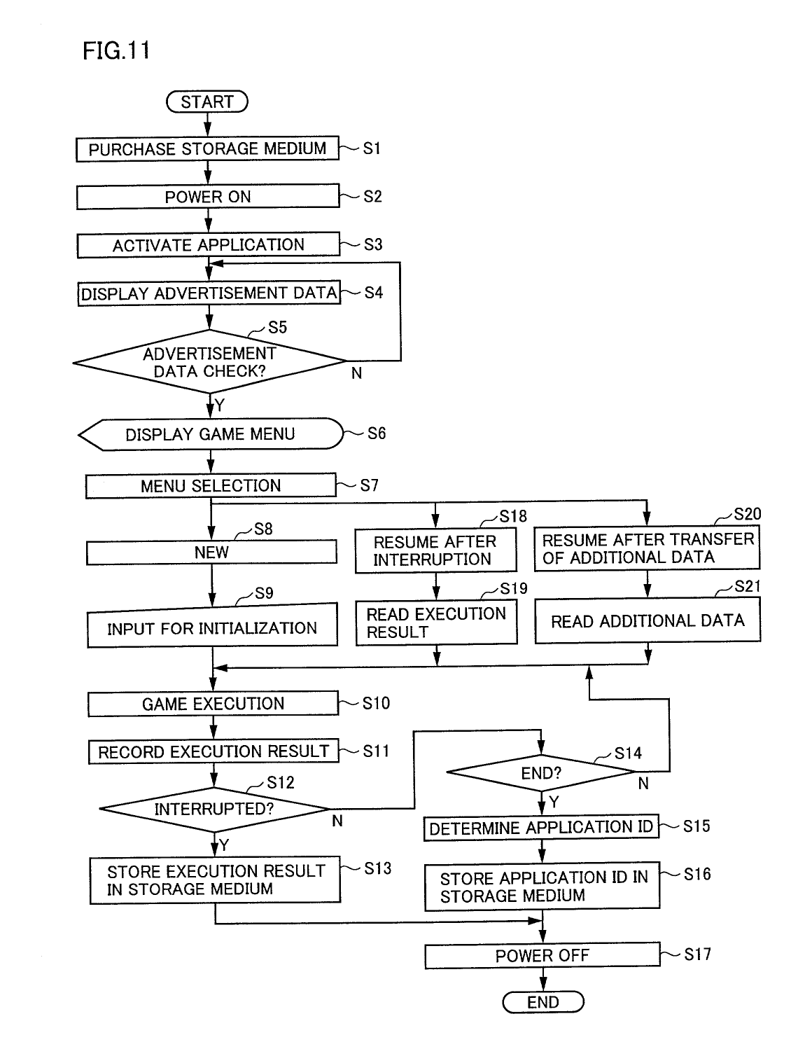

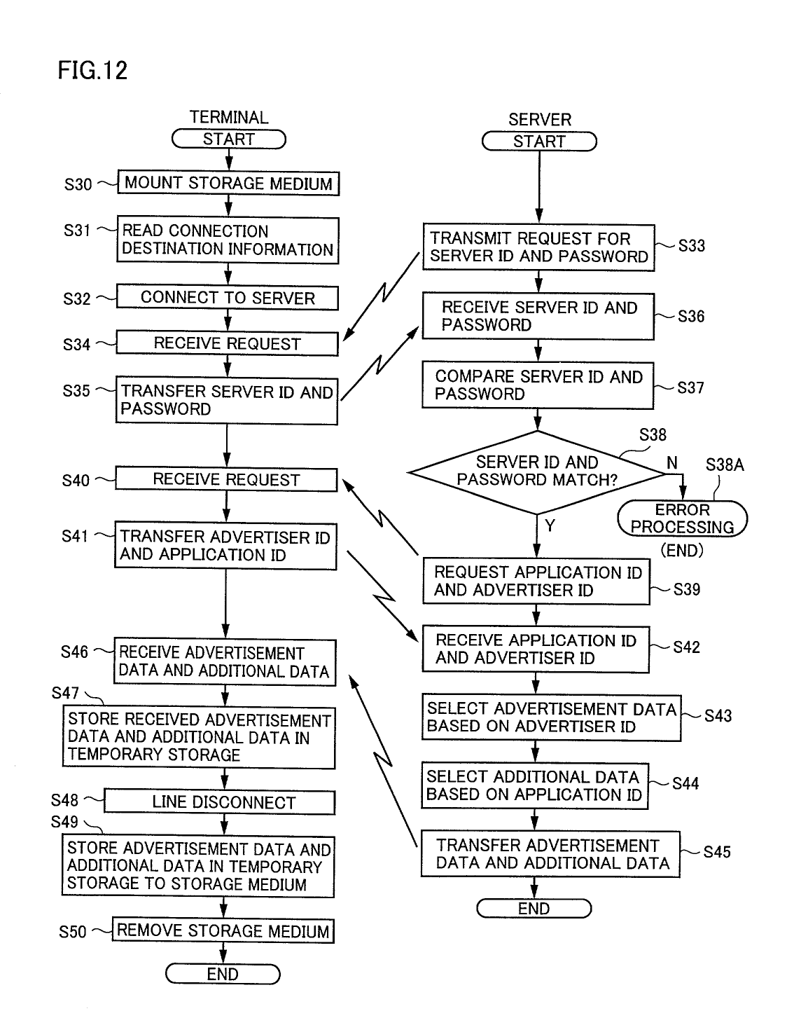

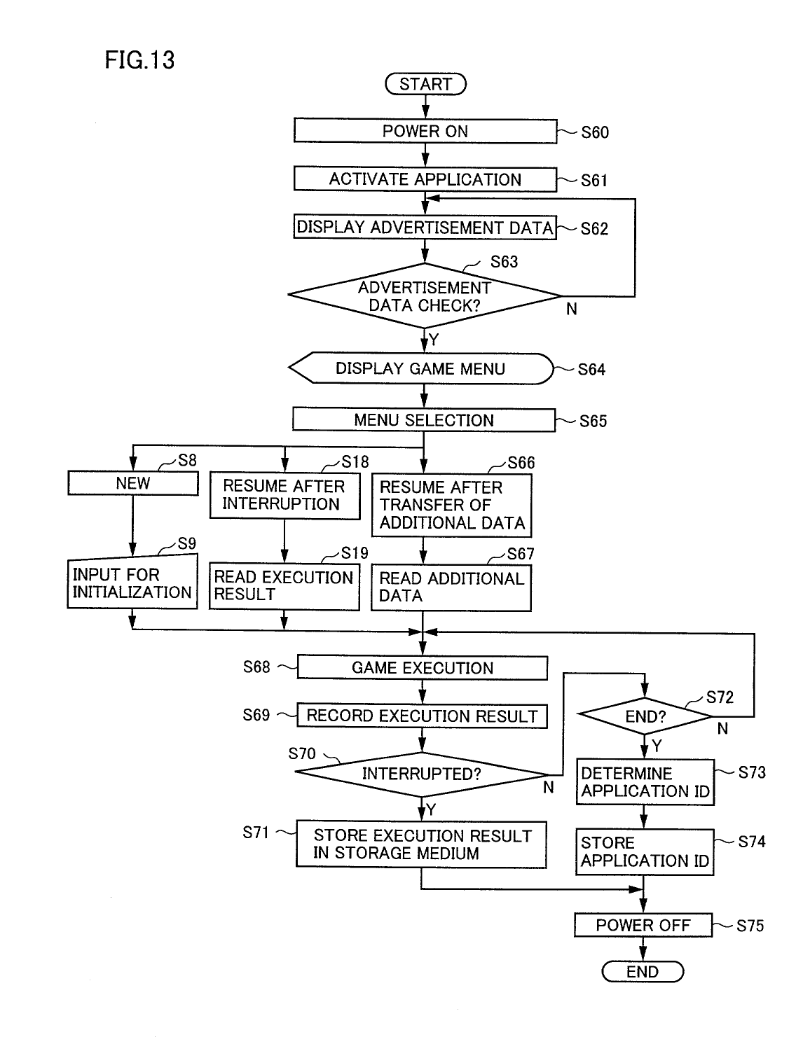

FIGS. 10A to 10E represent examples of images displayed when the game is executed by the terminal 500 in accordance with the present embodiment. FIG. 11 shows a flow chart when storage medium 400 is purchased and application 401A is executed at terminal 500 in accordance with the present embodiment. FIG. 12 shows a flow chart of data transfer process between terminal 200 and the prescribed server, in accordance with the present embodiment. FIG. 13 shows a flow chart of the process when the game execution is resumed, after additional data 402A is transferred, in accordance with the present embodiment.

Referring to the flow charts, an example will be described in which while the application 401A stored in storage medium 400 is executed, additional data 402A and advertisement data 404A related to application 401A are supplied to the user, through communication with the prescribed server.

The process when storage medium 400 storing application 401A is purchased and application 401A is activated will be described with reference to the flow chart of FIG. 11. The user purchases the storage medium 400 storing, in advance, application 401A, and mounts the storage medium 400 to interface 506 of terminal 500 (step S1: hereinafter step S will be simply denoted by S).

When storage medium 400 is mounted, the user operates to turn the power on through operating unit 504, and in response, control unit 502 reads and activates application 401A from the mounted storage medium 400 (S2, S3). When activated, control unit 502 reads advertisement data 404A of the mounted storage medium 400, and provides display of an image (see FIG. 10A) based on advertisement data 404A on display unit 503 (S4). When the user confirms the contents of the displayed advertisement data 404A and presses a button 600 on the screen (Y in S5), a menu display (see FIG. 10B) allowing selection of a desired operation among a plurality of operations related to the game appears (S6).

Referring to FIG. 10B, there are buttons 601, 602 and 603 displayed on the menu image. Button 601 is used to execute the game in accordance only with application 401A (without additional data) of storage medium 400. Button 602 is operated when execution of the game is interrupted and thereafter resumed. Button 603 is operated when the game is resumed after additional data 402A is supplied from the prescribed server and stored in additional data storing unit 402 of storage medium 400. When button 603 is operated with new additional data 402 not stored in storage medium 400, this operation is determined to be ineffective, and the message to that effect appears.

In order to execute the game of growing a virtual pet in accordance with application 401A of the purchased storage medium 400, the user operates button 601, and data for initialization is input through operating unit 504 in accordance with contents of instructions displayed on the display screen. For example, name of the virtual pet, type, name of the keeper and the like are input (S7-S9).

Thereafter, the game of growing the pet is executed using the input data. When the game is executed, images of the contents in accordance with the game progress are displayed. One example of the image displayed is as shown in FIG. 10C. The result in the middle of game execution is written and stored in temporary storage unit 501 (S10, S11).

As can be seen from FIG. 10C, there are a button 604 to be operated for interrupting execution of the game, and a button 605 operated to force termination of game execution, displayed on the image that appears when the game is being executed.

When the user wishes to stop the execution of the game, he/she operates the displayed button 604 (Yin S12), and intermediate result stored in temporary storage unit 501 of terminal 500 is stored as execution result 406A in execution result storing unit 406 of storage medium 400 mounted to interface 506 (S13), and thereafter, the user turns off the power of terminal 500 (S17). The intermediate result of the game stored in temporary storage unit 501 represent data of an action performed by the user to the pet during execution of the game. For example, hitting or stroking of the pet, conversation with the pet and so on.

When button 604 is not operated (N in S12), whether the user operates button 605 wishing to terminate execution of the game or not is determined. If the button is not operated (N in S14), the process proceeds to the step S10 described above. When the button is operated (S14), one application ID 48i is selectively determined (S15) among application ID information 480 of application 401A, based on the result of the action performed by the pet until the end of execution of the game. The determined application ID 48i is stored as execution result 406A in execution result storing unit 406 of storage medium 400 (S16). Thereafter, the power of terminal 500 is turned off (S17).

Thereafter, when the power of terminal 500 is turned on by the user and application 401A is read and activated from the mounted storage medium 400, the image (see FIG. 10A) in accordance with advertisement data 404A as described above appears on display unit 503, and after confirmation, the menu image (see FIG. 10B) of the game appears (S2-S6).

When the user operates button 602 of the displayed menu image (S7, S18), control unit 502 reads the execution result information 406A stored in execution result storing unit 406 of storage medium 400, that is, the information of the result in the middle of execution when the game execution is stopped last time, and based on the information, the game is executed in the similar manner as described above (S19, S10-S17). Thus, the game execution is restarted from the state when execution is stopped last time.

A process procedure when the user desires supply of corresponding additional data 402A so as to increase variety of the game in accordance with application 401A will be described in the following, with reference to the flow chart of FIG. 12.

In accordance with the flow chart of FIG. 11, the user terminates execution of the game (Y in S14), turns the power of terminal 500 off (S17), and removes storage medium 400 from terminal 500.

Referring to FIG. 12, the user mounts the storage medium 400 removed from terminal 500 to terminal 200 through interface 207 (S30).

Control unit 203 of terminal 200 reads the connection destination information 405A of connection destination information storing unit 405 of the mounted storage medium 400, and based on the read contents, establishes connection to the designated prescribed server through communication path connecting unit 201 and data communication path 300. Here, the prescribed server is assumed to be server 100 (S31, S32). In this manner, automatic connection to any one of the plurality of servers can be established.

When terminal 200 is connected, server 100 transmits a request for server ID 411 and password 412 to terminal 200. Upon reception of the request, terminal 200 accesses to the connection destination information storing unit 405 of storage medium 400, reads server ID 411 and server password 412 of connection destination information 405A and transmits the same to server 100 (S33-S35).

Receiving server ID 411 and password 421 transmitted from terminal 200, server 100 compares these with server ID 141 and password 142 stored in advance in connection permission information registration unit 140 (S36-S37). Based on the result of comparison, when server ID and the password do not match (N in S38), the following process steps are not performed, and an error message or the like is transmitted to terminal 200 and displayed (S38A).

When the server ID 411 and the password 412 match as a result of comparison (Y in S38), server 100 transmits the request of application ID and advertiser ID to terminal 200. Upon reception of the request, terminal 200 reads application ID 48i stored as execution result 406A in execution result storing unit 406 and advertiser ID 403A stored in advertiser ID storing unit 403 of storage medium 400, and transmits the same to server 100 (S39-S41).

Upon reception of the application ID 48i and advertiser ID 403A transmitted from terminal 200, server 100 searches the additional data storing unit 130 and advertisement data storing unit 120 based on the received application ID 48i and advertiser ID 403A to read corresponding registered additional data 13i and registered advertisement data 12i, and transmits the read data to terminal 200 (S42-S45). More specifically, data 13B and application information 13C corresponding to application ID 13A that matches application ID 48i, and data 12B corresponding to advertiser ID 12A that matches advertiser ID 403A are read and transmitted to terminal 200. Here, data 13B of registered additional data 13i transmitted to terminal 200 is, here, parameter data (data related to appearance, nature, knowledge and so on) of the pet that has grown in the game, for example.

Terminal 200 receives additional data including additional data 13B and application information 13C as well as the advertisement data including data 12B transmitted from server 100, stores the data in temporary storage unit 202, and thereafter, disconnects the communication line with server 100 through data communication path 300 (S46-S48). The received data may be directly written as additional data 402A and advertisement data 404A in additional data storing unit 402 and advertisement data storing unit 404 of the storage medium 400 mounted on terminal 200, without being temporarily stored in temporary storage 202.

After the communication line is disconnected, the additional data and the advertisement data stored in temporary storage unit 202 are stored as additional data 402A and advertisement data 404A in additional data storing unit 402 and advertisement data storing unit 404 of the mounted storage medium 400, and thereafter, the user removes storage medium 400 from terminal 200 (S49, S50).

By the above described procedure, it is possible for the user to obtain additional data 402A and advertisement data 404A in accordance with the result of execution of the game as desired, from the server 100.

Further, as data 12B of registered advertisement data 12i is updated, it is possible for the user to obtain the updated advertisement data 12b every time additional data 402A is presented. Therefore, it is possible for the user to easily obtain the latest version of the advertisement data related to application 401A as needed, and it is possible for the advertiser to surely and quickly present the advertisement data for sales promotion of application 401A or corresponding additional data 402A to the user who requires such advertisement data, without the necessity of preparing printings and the like.

The process procedure when the user wishes to execute the game using the supplied additional data 402A will be described with reference to the flow chart of FIG. 13.

When storage medium 400 in which additional data 402A and advertisement data 404A supplied from server 100 in accordance with the flow chart of FIG. 12 described above have been stored is mounted to terminal 500 through interface 506, the user turns the power on through operating unit 504 and then, in response, control unit 502 reads and activates application 401A from the mounted storage medium 400 (S60, S61). When activated, control unit 502 reads advertisement data 404A of the mounted storage medium 400, and controls display unit 503 so that an image (see FIG. 10D) based on the advertisement data 404A is displayed (S62). It is possible for the user to know the latest advertisement data 404A, by confirming the contents of the displayed advertisement data 404A. When the user presses “check” button 600 of the image, the menu image (see FIG. 10B) allowing selection of a desired operation item among a plurality of operation items for the game is displayed (S63, S64).

When a button 603 on the menu image is operated, control unit 502 reads additional data 402A stored in additional data storing unit 402 of storage medium 400, and starts execution of the game based on the already activated application 401A with the additional data (S65-S68). Thereafter, the game of growing the pet is executed in the similar manner as described above (the process of S10-S17) using the data of the grown pet (additional data 402A) (S68-S75). In this case, an image of FIG. 10E, for example, is displayed as an image of the grown pet.

The application ID that is determined in steps S73 and S74 of FIG. 13 at the end of execution of the game and stored as execution result 406A in execution result storing unit 406 of storage medium 400 is as follows. When the game is executed and terminated based only on application 401A, the application ID will be one application ID 48i selected from application ID information 480 of application 401A based on the results of actions of the pet performed until the end of execution of the game. When the game is executed and terminated based on application 401A and additional data 402A, the application ID is one application ID 49i selected from application ID information 490 of additional data 402A based on the results of actions performed by the pet until the end of execution of the game.

When the user stopped execution of the game (Y in S70), it is possible to resume execution of the game from the stopped state, through the same process steps (S18, S19) as described above (S68-S75).

When the user does not wish to execute the game using additional data 402A while additional data 402A has been supplied from the server 100, the operator operates “new button” 601 on menu image (S65). Therefore, the process for executing the game only in accordance with application 401A without using the additional data 402A is performed in the similar manner as described above (S8, S9, S68-S75).

In the above described manner, it is possible to enjoy the game for the grown pet, using additional data 402A supplied from server 100.

After the end of execution of the game in accordance with the flow of FIG. 13, when the user wishes to have additional data 402A supplied, the similar process as described with reference to FIG. 12 is performed, and data 13B and application information 13C of registered additional data 13i corresponding to the application ID (either the application ID 48i or application ID 49i) stored as the execution result in storage medium 400 are downloaded as additional data 402A, to storage medium 400. At this time, data 12B of registered advertisement data 12i corresponding to advertiser ID 403A of storage medium 400 is downloaded as advertisement data 404A to storage medium 400.

In the present embodiment, advertisement data 404A is described as displayed only once at the start of execution of the game. The data may be displayed during the progress of the game, and the number of display is not limited to one.

Terminal 200 is a portable terminal, and it may be a mobile terminal.

Though advertisement data 404A is described as having the contents related to the corresponding application 401A or additional data 402A, the contents may not be related thereto.

According to the present embodiment, as advertiser ID 403A is stored in storage medium 400, it is possible for the user to obtain the latest advertisement data 404A without the necessity of providing information of the user to the advertiser. Further, it becomes possible that part of the price of storage medium 400 storing application 401A is absorbed by the advertiser, in return for the presentation of advertisement data 404A. Accordingly, the sales price of storage medium 400 can be reduced, and the user can purchase the storage medium 400 at a low price. It is possible for the advertiser to appropriately and quickly present advertisement data 404A related to specific application 401A to the users interested in the specific application 401A, and therefore, it is possible to efficiently present the advertisement data 404A related to application 401A.

As additional data 402A and advertisement data 404A are stored in storage medium 400 using terminal 200 connected to data communication path 300, it is possible for the user to obtain at a desired time without any limitation of time and space, the latest additional data 402A and latest advertisement data 404A, and to use and confirm the data at a desired time without any limitation in time and space by the portable terminal 500.

Though information from server 100 is supplied to terminal 500 through terminal 200 and storage medium 400 in the above described process, the process can be similarly performed with the information adapted to be supplied to terminal 200A. Terminal 200A may be a mobile terminal that performs wireless communication with data communication path 300 using communicating path connecting unit 201, namely, wireless communication using electromagnetic wave or infrared ray. In that case, it is possible for the user to communicate and play the game while holding the terminal 200A, thus convenience of use can further be improved.

Second Embodiment

A second embodiment will be described. In the second embodiment, a procedure for an advertiser to register advertisement data in server 100 will be described. The server as the registration destination of advertisement data may be any server that supplies additional data 402A corresponding to application 401A that is advertised using the advertisement data supplied by the advertiser, and it is not limited to server 100.

Advertisement data of the advertiser can be registered with server 100 in the following method. For example, the advertiser prepares advertisement data for registration 12i by operating a terminal 10, transmits the prepared data through data communication path 300 to server 100, and server 100 stores the received advertisement data for registration 12i in advertisement data storing unit 120.

Alternatively, the following method may be used. When an advertiser asks an agent to prepare advertisement data 12i for registration, the agent prepares the requested advertisement data for registration 12i by operating a terminal 10, and transmits the prepared data through data communication path 300 to server 100. Server 100 stores the received advertisement data 12i for registration in the advertisement data storing unit 120.

As another alternative, the following method may be used. An advertiser sends by mail a storage medium storing the advertisement data 12i to be registered to a manager of server 100, and the manager stores the advertisement data for registration 12i stored in the received storage medium, to the advertisement data storing unit 120 of server 100.

As a still further method, an advertiser may ask an agent to prepare advertisement data 12i for registration, the agent prepares and stores the requested advertisement data for registration 12i in a storage medium, and sends the storage medium by mail to the manager of server 100. The manager stores the advertisement data for registration 12i stored in the received storage medium, to the advertisement data storing unit 120 of server 100.

Third Embodiment

In the present embodiment, the procedure for a data supplier to register additional data, registering the additional data 13i in additional data storing unit 130 of each server, will be described. Though the procedure for registering additional data 13i in server 100 is described here, the server as the registration destination is not limited thereto. Specifically, any server may be used, provided that the additional data supplied by the data supplier is registered.

The procedure for registering additional data is as follows. For example, a data supplier prepares additional data 13i to be registered by operating terminal 700, transmits the prepared data through data communication path 300 to server 100, and server 100 stores the received additional data 13i for registration in additional data storing unit 130. Further, the data supplier may prepare additional data 13i for registration and stores the data in a storage medium, and send the storage medium to a manager of server 100, and the manager may store the additional data 13i for registration stored in the received storage medium in the additional data storing unit 130 of server 100.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An information processing apparatus, comprising:
an information receiving unit receiving desired information together with advertisement data related to the desired information externally supplied from outside;
processing means for executing a prescribed process on said desired information received by said information receiving unit; and
advertisement presenting means for presenting, when said prescribed process is executed by said processing means, an advertisement based on said advertisement data received by said information receiving unit.

2. The information processing apparatus according to claim 1, wherein
said information receiving unit includes
a storage medium mounting unit to which an information storage medium storing in advance said desired information and said advertisement data is detachably mounted, and
a storage medium reading unit reading said desired information together with the advertisement data related to the desired information, from said information storage medium mounted on said storage medium mounting unit.

3. The information processing apparatus according to claim 1, wherein
said desired information includes additional data corresponding to a type to be added as an object of said prescribed process by said processing means.

4. The information processing apparatus according to claim 1, wherein
said information receiving unit has
a communication unit for communication with the outside through a communication path, and
receiving means for receiving, through said communication unit, said externally transmitted desired information and said advertisement data related to the desired information.

5. The information processing apparatus according to claim 4, wherein
said information receiving unit includes
additional data specifying means for specifying type of said additional data, based on execution result of said prescribed process by said processing means,
additional data requesting means for transmitting to the outside through said communication unit an acquisition for said additional data corresponding to the type specified by said additional data specifying means, and
data receiving means for receiving from the outside through said communication unit, said advertisement data and said additional data of the type corresponding to said acquisition request transmitted by said additional data requesting means.

6. The information processing apparatus according to claim 5, wherein
said acquisition request includes advertisement specifying data for specifying said advertisement data, and
said data receiving means receives said advertisement data specified by said advertisement specifying data included in said acquisition request transmitted by said additional data requesting means.

7. The information processing apparatus according to claim 1, wherein
said information processing apparatus is portable.

8. A communication apparatus, comprising:
a communication unit communicating with an external information supplying unit through a communication path;
receiving means receiving, through said communication unit, externally transmitted desired information for executing a prescribed process, and advertisement data related to the desired information;
a storage medium mounting unit on which a storage medium is detachably mounted; and
a storage medium writing unit writing said desired information and said advertisement data received by said receiving means to said storage medium mounted on said storage medium mounting unit.

9. The communication apparatus according to claim 8, wherein
said storage medium stores in advance information specifying data for specifying said desired information and advertisement specifying data for specifying said advertisement data;
said communication apparatus further comprising:
reading means for reading said information specifying data and said advertisement specifying data from said storage medium mounted on said storage medium mounting unit; and
request transmitting means for transmitting, through said communication unit, an acquisition request for said desired information and said advertisement data, using said information specifying data and said advertisement specifying data read by said reading means; wherein
said receiving means receives said desired information and said advertisement data specified by said information specifying data and said advertisement specifying data transmitted by said request transmitting means.

10. The communication apparatus according to claim 8, wherein
said storage medium stores in advance connection destination data for specifying and connecting to said external information supplying unit; and
said communication unit communicates with said external information supplying unit based on said connection destination data stored in said storage medium mounted on said storage medium mounting unit.

11. The communication apparatus according to claim 8, wherein
said desired information includes additional data to be added as an object of said prescribed process.

12. An information processing terminal, comprising:
a storage medium reading unit reading, from a storage medium storing desired information and advertisement data related to the desired information, said desired information and said advertisement data;
processing means for executing a prescribed process on said desired information read by said storage medium reading unit; and
advertisement presenting means for presenting, when said prescribed process is executed by said processing means, said advertisement data read by said storage medium reading unit.

13. The information processing terminal according to claim 12, further comprising
a storage medium mounting unit to which said storage medium is detachably mounted; wherein
said storage medium reading unit performs reading of said storage medium mounted on said storage medium mounting unit.

14. The information processing terminal according to claim 12, wherein
said desired information includes additional data corresponding to a type to be added as an object of said prescribed process by said processing means.

15. The information processing terminal according to claim 14, wherein
the type of said additional data is specified based on execution result of said prescribed process by said processing means.

16. The information processing terminal according to claim 12, wherein
said information processing apparatus is portable.

17. An information supplying apparatus, comprising:
acquisition request receiving means for receiving an acquisition request for desired information; and
data supplying means responsive to reception of said acquisition request by said acquisition request receiving means, for transmitting said desired information together with advertisement data related to the desired information, to a source of the acquisition request.

18. The information supplying apparatus according to claim 17, wherein
said desired information includes additional data corresponding to a type to be added as an object of information processing executed by said source of acquisition request.

19. The information supplying apparatus according to claim 18, wherein
said acquisition request includes type data representing type of said additional data;
said information supplying apparatus further comprising
an additional data storing unit storing a plurality of different said additional data; wherein
said data supplying means transmits, in response to reception of said acquisition request by said acquisition request receiving means, said additional data read from said additional data storing unit based on said type data in said received acquisition request to said source of acquisition request.

20. The information supplying apparatus according to claim 19, wherein
each of said plurality of different additional data of said additional data storing unit is registered and updated by a data supplier supplying the additional data.

21. The information supplying apparatus according to claim 17, wherein
said acquisition request includes advertisement specifying data for specifying said advertisement data;
said information supplying apparatus further comprising
an advertisement data storing unit storing a plurality of different said advertisement data; wherein
said data supplying means transmits, in response to reception of said acquisition request by said acquisition request receiving means, said advertisement data read from said advertisement data storing unit based on said advertisement specifying data in said received acquisition request, to said source of acquisition request.

22. The information supplying apparatus according to claim 21, wherein
said advertisement data storing unit stores said advertisement data corresponding to a plurality of advertisers supplying said advertisement data; and
said advertisement specifying data is data for specifying said advertiser.

23. The information supplying apparatus according to claim 22, wherein
said advertisement data in said advertisement data storing unit is registered and updated by corresponding said advertiser.

24. In an information processing system including a plurality of terminals executing a prescribed process on a desired information and presenting supplied data, and an information supplying apparatus communicating with an arbitrary one of said plurality of terminals for supplying information to said arbitrary terminal, a method of supplying information, comprising the steps of:
transmitting an acquisition request for said desired information from said arbitrary terminal to said information supplying apparatus; and
in response to reception of said acquisition request transmitted in said step of transmitting the acquisition request, transmitting and supplying said desired information together with advertisement data related to the desired information from said information supplying apparatus to said arbitrary terminal.

25. An information supplying system including a plurality of terminals executing a prescribed process on desired information and presenting supplied data, and an information supplying apparatus communicating with an arbitrary one of said plurality of terminals for supplying information to said arbitrary terminal, comprising:
acquisition request transmitting means for transmitting an acquisition request of said desired information from said arbitrary terminal to said information supplying apparatus; and
data supplying means responsive to reception of said acquisition request transmitted by said acquisition request transmitting means, for transmitting and supplying said desired information together with advertisement data related to the desired information, from said information supplying apparatus to said arbitrary terminal.

26. A computer readable recording medium, comprising:
a program information storing unit storing program information for executing a desired information processing;
an additional data storing unit storing additional data related to said program information read together with said program information for executing said desired information processing; and
an advertisement storing unit storing advertisement data related to said program information, read to be presented when said desired information processing is executed.

27. The computer readable recording medium according to claim 26, further comprising
advertisement specifying data storing unit storing advertisement specifying data for specifying said advertisement data; wherein
said advertisement data specified by said advertisement specifying data is externally supplied and stored in said advertisement storing unit.

28. The computer readable recording medium according to claim 27, further comprising
a connection destination information storing unit storing connection destination information for specifying and establishing connection for communication with a supplier of said advertisement data.

29. The computer readable recording medium according to claim 27, wherein
said advertisement specifying data is data for specifying an advertiser.

30. The computer readable recording medium according to claim 26, further comprising
identification information storing unit for storing identification information for uniquely identifying said additional data; wherein
said additional data specified by said identification information is externally supplied and stored in said additional data storing unit.

31. The computer readable recording medium according to claim 26, wherein
said additional data includes next order identification information for uniquely identifying said additional data to be added next, and said additional data specified by said next order identification information is externally supplied and stored in said additional data storing unit.

32. The computer readable recording medium according to claim 26, further comprising
execution result storing unit storing a result in the middle of or at the end of execution, when said desired information processing is executed.

33. The computer readable recording medium according to claim 32, wherein
one of said identification information and said next order identification information is stored as execution end result of said desired information processing into said execution result storing unit.
